(19) United States
(12) Patent Application Publication
(10) Pub. No.: US 2017/0024554 A1
(43) Pub. Date: Jan. 26, 2017

(54) SELF-POWERED, PORTABLE FINGERPRINT-ACTIVATED DEVICE FOR AUDIBLY OUTPUTTING PERSONAL DATA

(71) Applicants: Asher Segal, Staten Island, NY (US); Avram Matcovitch, Nesher (IL)

(72) Inventors: Asher Segal, Staten Island, NY (US); Avram Matcovitch, Nesher (IL)

(21) Appl. No.: 15/046,543

(22) Filed: Feb. 18, 2016

Related U.S. Application Data
(60) Provisional application No. 62/194,590, filed on Jul. 20, 2015.

(51) Int. Cl. G06F 21/32; G06F 19/00; G06F 21/62; G10L 13/08; G06K 9/00

(52) U.S. Cl. CPC G06F 21/32; G10L 13/08; G06K 9/0002; G06K 9/00087; G06K 9/0004; G06F 21/6245; G06F 19/322

(57) ABSTRACT

A self-powered, portable fingerprint-activated apparatus for audibly outputting personal data includes a memory, a fingerprint scanner, circuitry, and a self-powered power cell. The memory is configured to pre-store the personal data including a fingerprint of a subject. The circuitry is configured to compare a scanned fingerprint from the scanner with the pre-stored fingerprint of the subject and to audibly output the pre-stored personal data upon authenticating the scanned fingerprint of the subject. The self-powered power cell is configured to power the circuitry.

### CROSS REFERENCE TO RELATED APPLICATIONS

The present application claims the benefit of U.S. Provisional Patent Application No. 62/194,590, filed on Jul. 20, 2015, which is incorporated in its entirety herein by reference.

### FIELD OF THE INVENTION

Embodiments of the present invention relate to secure data management. Specifically, some embodiments of the present invention relate to a self-power portable fingerprint-activated device for audibly outputting personal data.

### BACKGROUND OF THE INVENTION

Managing access to systems holding personal data is becoming increasingly difficult due to hacker and criminal activity. To access personal data from a data system, a user may input a password or personal identification number, a security chip, token, or smart card, or biometric information. Biometric authentication is considered the most secure form of identification using biometrics such as signature dynamics, eye scans, fingerprint recognition, hand or palm print geometry, voice recognition, and facial recognition.

### SUMMARY OF THE INVENTION

There is thus provided, in accordance with some embodiments of the present invention, a self-powered, portable fingerprint-activated apparatus for audibly outputting personal data including a memory, a fingerprint scanner, circuitry, and a self-powered power cell. The memory is configured to pre-store personal data including a fingerprint of a subject. The circuitry is configured to compare a scanned fingerprint from the scanner with the pre-stored fingerprint of the subject and to audibly output the pre-stored personal data upon authenticating the scanned fingerprint of the subject. The self-powered power cell is configured to power the circuitry.

Furthermore, in accordance with some embodiments of the present invention, the circuitry is configured to audibly output the pre-stored personal data by converting the pre-stored personal data to an audio signal waveform, and outputting the audio signal waveform via a loudspeaker.

Furthermore, in accordance with some embodiments of the present invention, the pre-stored personal data includes limited personal data and comprehensive personal data, and the circuitry is configured to audibly output the limited personal data upon authenticating the fingerprint of the subject and to permit an external device to access the comprehensive personal data over a communication link interface upon receiving a secondary authentication from the external device.

Furthermore, in accordance with some embodiments of the present invention, the secondary authentication includes a password received from the external device through a cable connected between the external device and the communication link interface.

Furthermore, in accordance with some embodiments of the present invention, the circuitry is configured to permit the external device to access the comprehensive personal data over a cable connected between the external device and the communication link interface.

Furthermore, in accordance with some embodiments of the present invention, the communication link interface comprises a Universal Serial Bus (USB) interface.

Furthermore, in accordance with some embodiments of the present invention, the circuitry is configured to generate an alarm signal upon assessing that the subject has contacted the fingerprint scanner for a predefined period of time.

Furthermore, in accordance with some embodiments of the present invention, the limited personal data is selected from the group consisting of a name of the subject, an address of the subject, contact details of a doctor of the subject, a birth date of the subject, a list of medications of the subject, a list of allergies of the subject, a list of medication sensitivities of the subject, major medical problems of the subject, insurance information of the subject, a list of prior surgeries and medical procedures of the subject, lifestyle information of the subject, assistive equipment of the subject, cultural concerns and religious beliefs of the subject impacting on medical care, and a health care proxy of the subject.

Furthermore, in accordance with some embodiments of the present invention, the comprehensive personal data includes a medical history of the subject stored in a data folder in the memory.

Furthermore, in accordance with some embodiments of the present invention, the circuitry is configured to convert a voice recording of the personal data to a digital data stream that is stored in the memory.

Furthermore, in accordance with some embodiments of the present invention, the pre-stored personal data includes a plurality of voice recordings in respective multiple languages stored in the memory, and the circuitry is configured to audibly output the pre-stored personal data in a selected language by audibly replaying one from the plurality of stored voice recordings with the preset language.

Furthermore, in accordance with some embodiments of the present invention, the pre-stored personal data includes a stored text message, and the circuitry is configured to audibly output the preselected personal data by applying a text-to-speech engine to the stored text message.

Furthermore, in accordance with some embodiments of the present invention, the pre-stored personal data includes a plurality of text messages with the pre-stored personal data in respective multiple languages, and the circuitry is configured to select one from the plurality of text messages with a preset language, to apply a text-to-speech engine to the selected text message, and to audibly output the pre-stored personal data in the preset language.

Furthermore, in accordance with some embodiments of the present invention, the pre-stored personal data includes a text message with the pre-stored personal data in a first language, and the circuitry is configured to translate the text message from the first language to a preset second language, to apply a text-to-speech engine to the translated text message, and to audibly output the pre-stored personal data in the preset second language.

Furthermore, in accordance with some embodiments of the present invention, the self-powered power cell includes a solar cell panel.

Furthermore, in accordance with some embodiments of the present invention, the apparatus includes a battery, which is configured to power the circuitry, and the self-powered power cell is configured to charge the battery.

Furthermore, in accordance with some embodiments of the present invention, the fingerprint scanner includes an optical fingerprint scanner.

Furthermore, in accordance with some embodiments of the present invention, the fingerprint scanner includes a capacitive fingerprint scanner.

Furthermore, in accordance with some embodiments of the present invention, the fingerprint scanner is configured to detect from the scanned fingerprint whether the subject is alive.

There is further provided, in accordance with some embodiments of the present invention, a method including pre-storing personal data further including a fingerprint of a subject in a memory. A scanned fingerprint is compared with the pre-stored fingerprint of the subject. Upon authenticating the scanned fingerprint, the pre-stored personal data is audibly outputted.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a fingerprint-activated device for audibly outputting personal data of a subject, in accordance with some embodiments of the present invention;

FIG. 1B schematically illustrates a fingerprint-activated device emitting an alarm signal for alerting bystanders, in accordance with some embodiments of the present invention;

FIG. 2 schematically illustrates a front side and a back side of a fingerprint-activated device, in accordance with some embodiments of the present invention;

FIG. 3 schematically illustrates a block diagram of a fingerprint activated device, in accordance with some embodiments of the present invention; and

FIG. 4 is a flowchart illustrating a method for audibly outputting personal data from a fingerprint activated device, in accordance with some embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, us of the conjunction “or” as used herein is to be understood as inclusive (any or all of the stated options).

A subject, or patient, requiring medical attention in an emergency situation needs to relay his/her personal data to a paramedic or other health care professional such as his/her name, medical statistics, medical insurance, pre-existing health conditions, and other information. This personal data is critical for the health care professional to know prior to administering treatment. In the event that the subject is unconscious or unable to relay personal details, the subject is typically treated on the basis of exhibited symptoms when the subject's medical history is not available. Receiving treatment without knowledge of the subject's identity, the subject's concomitant diseases such as diabetes or heart disease, medication the subject is taking, or allergies may be dangerous for the subject. Furthermore, the administration of medical treatment to the subject may be delayed while the health care professionals attempt to identify the subject, locate relatives, or locate health records. These delays in administering treatment may be critical in determining whether the subject survives the medical emergency.

However, to carry the subject's personal details in the event of such emergency situations on the subject's body stored in non-secure devices, such as cellular and smart phone devices, or any wireless enabled device, creates an opportunity for hackers and criminals to intercept the personal data. The intercepted personal data can then be used in criminal activities, such as identity theft.

Some embodiments of the present invention described herein provide a device, system and method for audibly retrieving personal data pre-stored on a device after authenticating biometric information such as a person's fingerprint to release the personal data. The device is a self-powered, portable device that includes a self-powered power cell, such as a solar cell panel which operates using solar energy, e.g., green technology. The device does not include wireless communication technology or protocols, such as Bluetooth or Wireless Fidelity (WiFi), so as to prevent any possible interception of the subject's pre-stored personal data stored on the device.

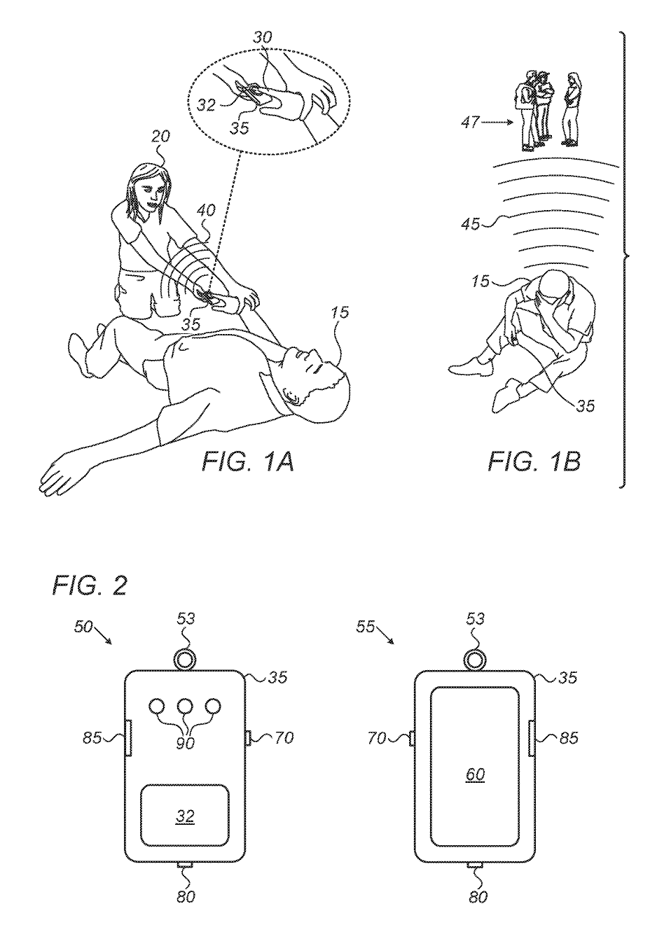

FIG. 1A schematically illustrates a fingerprint-activated device 35 for audibly outputting 40 personal data of a subject 15, in accordance with some embodiments of the present invention. Personal data of subject 15 is securely pre-stored on fingerprint-activated device 35 and carried on subject 15. If the subject loses consciousness, or if due to other personal limitations such as memory and/or speech and/or hearing impairments, subject 15 may not be able to convey his personal and medical data to emergency service personnel (e.g., a paramedic 20). In such events, paramedic 20 can initially retrieve the critical medical data securely stored on device 35 needed to treat subject 15.

To retrieve the pre-stored personal data, a finger 30 of subject 15 is placed on a fingerprint scanner 32 on fingerprint-activated device 35. When the fingerprint of subject 30 is authenticated by fingerprint-activated device 35, pre-stored personal data (in this case—medical data) on device 35 is audibly outputted 40 for paramedic 20 to hear and retrieve. By audibly outputting the personal data to paramedic 20 in response to authenticating the fingerprint of subject 15, the personal data remains secure from hackers and criminals since the pre-stored personal data can only be heard by people in the vicinity of device 35 such as paramedic 20 or any other people to aid subject 15. In this manner, the personal data may not be intercepted by any other means.

In some embodiments of the present invention, device 35 is configured to repeat audibly outputting the personal data each time the finger of the subject is placed on scanner 32. This way it is assured that paramedic 20 entirely receives the personal data, and may repeat the playing of the personal data if for any reason it is needed.

FIG. 1B schematically illustrates fingerprint-activated device 35 emitting an alarm signal 45 for alerting bystanders 47, in accordance with some embodiments of the present invention. In the event that subject 15 is feeling sick or incapacitated, subject 15 can then hold finger 30 on fingerprint scanner 32 for a predefined period of time, for example 30-45 seconds, and device 35 then emits an alarm signal 45 after the predefined period of time. Alarm signal 45 alerts bystanders 47 in the vicinity that subject 15 is in need of assistance.

FIG. 2 schematically illustrates a front side 50 and a back side 55 of fingerprint-activated device 35, in accordance with some embodiments of the present invention. Device 35 may be shaped in any form factor for comfortably carrying the device on the body of subject 15 and for easy accessibility for paramedic 20, emergency medical service personnel, or any authorized individuals to retrieve the personal data pre-stored thereon. Device 35 may also be designed as a keychain for holding keys, or ornamental jewelry, for example, a necklace or a bracelet, where a chain can be coupled to device 35 by threading the chain through a loop 53 formed in the body of device 35 such that the chain and device 35 may be worn around a neck or a wrist of subject 15. Device 15 may be configured to be worn on subject 15 in any suitable manner and/or designed to be carried in the subject's pocket and/or purse. In some embodiments, device 35 may be waterproof.

Front view 50 of device 35 includes fingerprint scanner 32, a speaker 85, an on/off switch 70, and light emitting diodes (LED) indicators 90. Light emitting diodes may be configured to indicate device status such as whether device 35 is powered up, unlocked after fingerprint authentication, and/or enabled to release pre-stored personal data, for example. Back side 55 of device 35 includes a solar cell panel 60 for converting solar energy to electrical energy to power device 35.

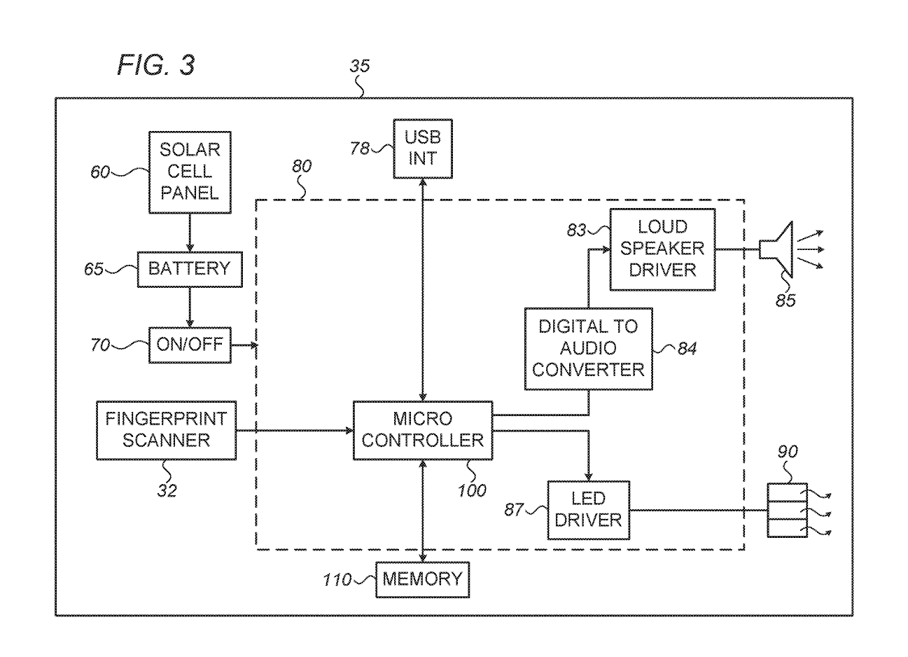

FIG. 3 schematically illustrates a block diagram of fingerprint-activated device 35, in accordance with some embodiments of the present invention. Fingerprint-activated device 35 includes circuitry 80 as shown in the dotted rectangle of FIG. 3, which further includes a micro-controller 100 that is used to read/write the personal information onto a memory 110. Microcontroller 100 receives inputs from fingerprint scanner 32 when finger 30 of subject 15 is placed on fingerprint scanner 32. Microcontroller 100 uses the inputs to authenticate the fingerprint on finger 30 of subject 15 by comparing the inputs to a pre-stored fingerprint of subject 15. After microcontroller 100 authenticates the subject's fingerprint, microcontroller 100 fetches the pre-stored personal data from memory 110 and converts the data to audible signal 40 for paramedic 20 to hear.

In some embodiments of the present invention, the pre-stored personal data may be converted to an audio signal waveform in a digital-to-audio converter unit 84 which is coupled to a loudspeaker 85 via a loudspeaker driver 83. In some embodiments, microcontroller 100 may include the functions of unit 84. In other embodiments, digital to audio converter unit 84 may be a standalone unit as shown in FIG. 3. Microcontroller 100 may report the status of device 35 by use of indicator LED 90 via an LED driver 87.

In some embodiments of the present invention described herein, individuals authorized to modify or delete the pre-stored personal data of subject 15 in memory 110 may access, or change, the data using an external computing device (not shown) connected to device 35 via a communication link, such as, for example, universal serial bus (USB) interface 78.

In some embodiments of the present invention, USB interface 78 may include any USB connection, such as a superspeed USB 3.1 interface connection. In other embodiments, device 35 may also be configured to receive electrical power over USB interface 78, which can be used to power device 35 and/or charge battery 65.

Fingerprint-activated device 35 also includes solar cell panel 60, which can be used to charge a battery 65. Solar panel 60 and/or battery 65 may be used to power the elements in circuitry 80 or coupled to circuitry 80 as shown in FIG. 3.

In some embodiments of the present invention, device 35 may not only include solar panel 60 as shown in FIG. 3, but may also include any self-powered power cells. Solar cell panel 60 in FIG. 3 may be replaced by a self-powered power cell as described herein below. In some embodiments, the self-powered power cells include thermoelectric devices that use the thermoelectric effect where a temperature difference across the device creates an electric potential, which can be used to power device 35. In some embodiments, self-powered power cell may include a thermopile device, which also converts thermal energy to electrical energy. The thermopile device may include several thermocouples connected in series, or less commonly, in parallel, which can be used to power device 35. In some embodiments, the self-powered power cells may include piezoelectric devices which converts mechanical stress to electrical energy and may be configured to power device 35.

In some embodiments of the present invention, the self-powered power cell may be configured to receive electromagnetic energy by inductive coupling. The electromagnetic energy is generated typically in a charging station. The received electromagnetic energy may be used to charge the battery or power the circuitry in device 35. In some embodiments, near field resonant inductive coupling between two magnetically coupled coils (e.g., electrodynamic induction) may be used to generate electrical energy in the self-powered power cell which is configured with resonant circuitry that resonates at the same resonant frequency as the magnetically coupled coils. The received resonant electrical energy in device 35 may be used to charge the battery or power the circuitry in device 35.

In some embodiments of the present invention, when subject 15 is feeling sick or incapacitated and in need of assistance, subject 15 can push, hold, contact or apply pressure with finger 30 on the surface of scanner 32. Circuitry 80 in device 35 is configured to generate alarm signal 45 upon assessing that subject 15 has contacted the fingerprint scanner 32 with finger 30 for a predefined period of time as shown in FIG. 1B. Alarm signal 45 emitted from loudspeaker 85 alerts bystanders 47 in the vicinity of device 35 that subject 15. In some embodiments, after fingerprint scanner 32 authenticates the fingerprint of subject 15, device 35 starts to audibly output the pre-stored personal data for the case of paramedic 20 holds finger 30 on scanner 32 when subject 15 is unconscious only to audibly retrieve the personal data. However, if the subject 15 is conscious but needs assistance, subject 15 holds finger 30 on scanner 32 and device 35 starts to audibly output the personal data. However, after circuitry 80 assesses that subject 15 held finger 30 on scanner 32 for a predefined period of time, circuitry 80 causes alarm signal 45 to be emitted from speaker 85.

The block diagram of device 35 as shown in FIG. 3 is merely for visual clarity and not by way of limitation of the embodiments of the present invention. Any suitable configuration of a solar-powered fingerprint-activated device for audibly outputting secure personal data may be implemented.

In some embodiments of the present invention, device 35 may require two or more additional levels of authentication to unlock device 35 after fingerprint authentication. Device 35 may use an additional password that is known to authorized health care professionals to permit access to more comprehensive personal data stored in memory 110 in addition to the limited pre-stored personal data, which is audibly output. For example, paramedic 20 hears audio signal 40 of the limited (basic) medical data of subject 15 to identify subject 15 and retrieve basic medical details before applying initial medical treatment. Upon arrival to the hospital, a health care professional may further access and/or download more comprehensive medical data pre-stored on device 35 only after fingerprint authentication and after using an additional password for secondary authentication. Any suitable number of levels of authentication or types of authentication may be added optionally and is not limited to the embodiments described herein.

In some embodiments of the present invention, the limited personal data may include the name and address of the subject, or patient, the name and contact details the subject's doctor, birth date, a list of medications current being taken by subject 15, a list of allergies, sensitivities to certain medications, major medical problems such as diabetes, cancer or heart disease, list of medications, insurance information, such as insurance company, coverage, and policy number. The limited pre-stored personal data may also include prior surgeries and medical procedures, lifestyle information such as the use of alcohol or tobacco, cultural concerns and religious beliefs if they impact medical care, assistive equipment such as canes, wheelchairs, hearing aids, false teeth, and health care proxy such as whether another personal was designated as the patient's health care agent to make all of the patient's health care decisions should the patient become unable to make or communicate those decisions.

In some embodiments of the present invention, the comprehensive pre-stored personal data may also include large volumes of medical data stored in a data folder in memory 110 with the medical history of the patient. This medical data may further include, for example, X-ray computerized tomography (CT) scan data, computerized axial tomography (CAT) scan data, and magnetic resonance imaging (MRI) scan data, or any other relevant comprehensive medical data, if the patient data is not readily available to the health care personnel in a database, such as a medical database.

In some embodiments of the present invention, the pre-stored personal data may be uploaded and/or downloaded between an external device and device 35 via USB interface 78 when device 35 is placed in a data preloading mode after authentication. In data preloading mode, the personal data from an external data source, such as a computer or server, can be uploaded to device 35. For example, device 35 may be connected to an external computer via USB interface 78, for example over a data cable coupling device 35 to the external computer over which additional password may be sent to device 35 from the external computer. Upon microcontroller 100 authenticating the additional password, microcontroller 100 may be then permit accessibility by health care personnel to the comprehensive personal data of subject 15 in memory 110 pre-stored on device 35 for viewing on and/or downloading to an external computer. In some embodiments, new data related to the current treatments received by the patient may be uploaded to the medical history data folder stored in memory 110 on device 35.

In some embodiments of the present invention, the limited pre-stored information may include a voice recording with the medical data that is stored in memory 110 as a digital recording. In some embodiments, microcontroller 110 converts the voice audio signal captured by a microphone, for example, into a digital data stream of discrete numbers representing, for example, changes over time in air pressure in the microphone. This digital data stream may then be stored in memory 110. When the fingerprint of subject 15 is authenticated, microcontroller 100 may fetch the digitized stored voice recording from memory 110. In some embodiments, digital-to-audio converter module 84 may include digital-to-analog converters which are configured to convert digital data stream stored in memory 110 to an audio signal. The audio signal can be amplified in a loudspeaker driver 83. The pre-stored voice recording with the limited medical data is then output as audio signal 40 to paramedic 20.

In some embodiments of the present invention, digital-to-audio converter 84, loudspeaker 85, and driver 83 may be configured to operate bi-directionally and used as a recording unit to record voice signal with the predefined personal data when device 15 is in preload mode. Loudspeaker 85 may be configured to function as a microphone, or may include a stand-alone, separate or integrated microphone unit. Digital-to-audio converter 84 may also include analog-to-digital converters to convert the voice signal to a digitized data stream for storage in memory 110. In some embodiments, multiple voice recordings with the subject's personal data in multiple languages may be pre-stored. Device 35 may be configured to audibly output the subject's personal data in a language chosen from one of the pre-stored multiple voice recordings, such as when subject 15 is travelling in a different country.

Circuitry 80 includes microcontroller 100 which may include one or more processor cores. Microcontroller 100 may be implemented on a single chip along with other peripherals such as memory 110. In other embodiments, circuitry 80 may be implemented using multiple stand-alone packaged chips mounted on a printed circuit board. Microcontroller 100 may be configured to operate in accordance with programmed instructions stored in memory 110. Microcontroller 100 may be capable of executing all of the functions described herein for authenticating subject 15 using with different levels of biometric and secondary authentication. After biometric fingerprint authentication, microcontroller 100 permits access to pre-stored personal data stored on memory 110 such that limited personal data is audibly output over speaker 85. Further upon both biometric fingerprint and secondary authentication, microcontroller 100 permits other users to manage more comprehensive data stored in memory 110, such as preloading, changing, or deleting data in the patient's medical history data folder in memory 110.

In some embodiments of the present invention, when device 35 is configured to permit access to the limited and/or comprehensive personal data in memory 110, microcontroller 100 may communicate with any suitable output device via USB interface 78 only after proper authentication is obtained as previously described. Such output devices may include a computer, external memory, printer, display panel, external speaker, or another device capable of producing visible, audible, or tactile output.

In some embodiments of the present invention, device 35 may be configured to operate using radio-frequency identification (RFID). Device 35 may include identifying and tracking RFID tags which may be used to identify and authenticate subject 15 when the tags are powered by electromagnetic induction from a magnetic field produced near device 35. In other embodiments, active RFID may also include two-way communication.

Microcontroller 100 may communicate over USB interface 78 with any input device when device 35 is placed in data preloading mode. For example, input devices may include one or more of a keyboard, keypad, or pointing device for enabling personal data and/or instructions for operation of microcontroller 100.

Microcontroller 100 may communicate with memory 110. Memory 110 may include one or more volatile or nonvolatile memory devices, such as flash memory. Memory 110 may be utilized to store, for example, programmed instructions for operation of microcontroller 100, data or parameters for use by microcontroller 100 during operation, or results of operation of microcontroller 100.

In some embodiments, fingerprint scanner 32 may include an optical scanner which is configured, for example, with an array of charge coupled devices (e.g., photodiode). Finger 30 is place on the surface of fingerprint scanner 32 which is illuminated by a light source from the scanner. Each photodiode in the array records a pixel from the light reflected from a spot on the fingerprint to the photodiode, which generates an electrical signal in response to the intensity of the reflected light. The electrical signals from each pixel in the array are then used to create a representation of the scanned fingerprint. The scanned fingerprint from fingerprint scanner 32 may then be coupled to microcontroller 100 via any suitable bus. Microcontroller 100 may then compare the scanned fingerprint from the optical fingerprint scanner with the pre-stored fingerprint of subject 15 in memory 110 so as to authenticate the fingerprint of subject 15.

In some embodiments of the present invention, fingerprint scanner 32 may include a capacitive finger scanner. The surface of fingerprint scanner 32 includes arrays of capacitor cell electrodes each cell connected to electrical sensors. The capacitance of cell is modified when the finger is placed over the multiple cells, where fingerprint ridges and fingerprint valleys each generate a difference capacitance when contacting the array of cell electrodes. The capacitance of each cell in the array is used to create a representation of the scanned fingerprint. The scanned fingerprint from fingerprint scanner 32 may then be coupled to microcontroller 100 via any suitable bus. Microcontroller 100 may then compare the scanned fingerprint from the capacitive fingerprint scanner with the pre-stored fingerprint of subject 15 in memory 110 so as to authenticate the fingerprint of subject 15.

In some embodiments of the present invention, microcontroller 100 may be configured to detect from the scanned fingerprint from fingerprint scanner 32 whether subject 15 is alive. For example, scanner 32 may operate with Matrix Pinhole Imaging Sensor (MAPIS) technology. MAPIS technology uses sweat pore detection and recognition that is very reliable to assess whether subject 15 is dead or alive.

In some embodiments of the present invention, solar cell panel 60 may include one solar cell device or multiple solar cell devices arranged in an array. Solar cell panel 60 may be used to charge battery 65 as shown in FIG. 3. Alternatively and/or additionally, solar cell panel 60 may also be used to directly power circuitry 80, and any other elements of device 35 connected to circuitry 80. Battery 65 typically includes rechargeable-type batteries, such as nickel-cadmium (NiCd), nickel-metal hydride (NiMH), lithium ion, and lithium-ion polymer batteries, but may include any suitable battery type. On/off switch 70 is shown in FIG. 3 in a serial connection between battery 65 and circuitry 80. Alternatively and/or additionally, on/off switch may be used in any suitable configuration to power on and/or power off device 35. The serial connection of solar cell panel 60, battery 65, and on/off switch 70 is shown merely for conceptual clarity, and not by way of limitation of some embodiments of the present invention described herein. Any suitable power management configuration may be used to couple power to circuitry 80 and subsequently additional elements connected to circuitry 80, such as memory 110, USB Interface 78 and fingerprint scanner 32.

In some embodiments of the present invention, the limited personal data may be pre-stored as a text message. Microcontroller 100 may be programmed to apply a text-to-speech (TTS) engine, or algorithm, to the stored text message. The engine may include, for example, a text analysis module which assigns a series of phonetic transcriptions to each word in the text message, and then divides the text into prosodic units. The phonetic transcriptions and the prosodic units form a symbolic linguistic representation. The text-to-speech engine also includes a synthesizer module that converts the symbolic linguistic representation to a speech waveform which can be audibly outputted to paramedic 20. In some embodiments, the digital speech waveform may be converted to an analog (audio) waveform in digital-to-audio converter 84 and then audibly outputted from speaker 85.

Subject 15 may be travelling and subject 15 presets the location (e.g., country) of device 35. Alternatively, subject 15 may simply preset the output language. In some embodiments, the limited personal data may be pre-stored in multiple text messages, each text message in a different language so as to cover different countries. In some embodiments of the present invention, the output language may be selected by the person operating device 35 (e.g., a paramedic), from a list of languages offered on a display panel associated with device 35. The TTS engine may be configured to operate in different languages and dialects. Depending on the preset language, microcontroller 100 may select the text message with the preset language and the TTS engine converts the limited personal data to an audible output in the preset language.

In some embodiments of the present invention, the limited personal data may be pre-stored in a first language. Microprocessor 100 may execute a machine translation program to convert the text in the first language to text in a second preset language. TTS engine may then convert the limited personal data to an audible output in the second preset language.

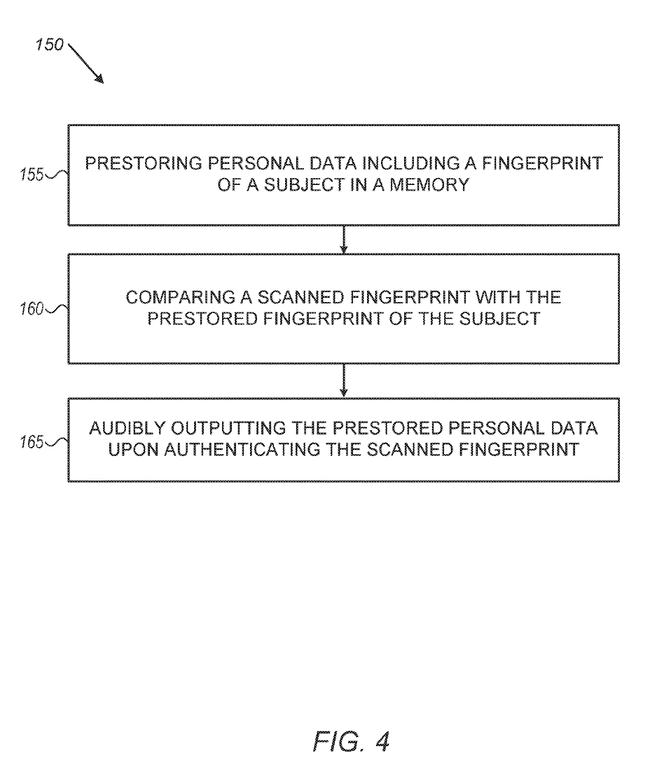

FIG. 4 is a flowchart illustrating a method 150 for audibly outputting personal data from fingerprint activated device 35, in accordance with some embodiments of the present invention. Method 150 includes pre-storing personal data including a fingerprint of subject 15. Method 150 includes comparing a scanned fingerprint with the pre-stored fingerprint of subject 15. Method 150 includes audibly outputting the pre-stored personal data upon authenticating the scanned fingerprint.

It should be understood, with respect to any flowchart referenced herein, that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A self-powered, portable fingerprint-activated apparatus for audibly outputting personal data, the apparatus comprising:
a memory, which is configured to pre-store personal data including a fingerprint of a subject;
a fingerprint scanner;
circuitry, which is configured to compare a scanned fingerprint from the scanner with the pre-stored fingerprint of the subject and to audibly output the pre-stored personal data upon authenticating the scanned fingerprint of the subject; and
a self-powered power cell, which is configured to power the circuitry.

2. The apparatus according to claim 1, wherein the circuitry is configured to audibly output the pre-stored personal data by converting the pre-stored personal data to an audio signal waveform, and outputting the audio signal waveform via a loudspeaker.

3. The apparatus according to claim 1, wherein the pre-stored personal data comprises limited personal data and comprehensive personal data, and wherein the circuitry is configured to audibly output the limited personal data upon authenticating the fingerprint of the subject and to permit an external device to access the comprehensive personal data over a communication link interface upon receiving a secondary authentication from the external device.

4. The apparatus according to claim 3, wherein the secondary authentication comprises a password received from the external device through a cable connected between the external device and the communication link interface.

5. The apparatus according to claim 3, wherein the circuitry is configured to permit the external device to access the comprehensive personal data over a cable connected between the external device and the communication link interface.

6. The apparatus according to claim 3, wherein the communication link interface comprises a Universal Serial Bus (USB) interface.

7. The apparatus according to claim 1, wherein the circuitry is configured to generate an alarm signal upon assessing that the subject has contacted the fingerprint scanner for a predefined period of time.

8. The apparatus according to claim 3, wherein the limited personal data is selected from the group consisting of a name of the subject, an address of the subject, contact details of a doctor of the subject, a birth date of the subject, a list of medications of the subject, a list of allergies of the subject, a list of medication sensitivities of the subject, major medical problems of the subject, insurance information of the subject, a list of prior surgeries and medical procedures of the subject, lifestyle information of the subject, assistive equipment of the subject, cultural concerns and religious beliefs of the subject impacting on medical care, and a health care proxy of the subject.

9. The apparatus according to claim 3, wherein the comprehensive personal data comprises a medical history of the subject stored in a data folder in the memory.

10. The apparatus according to claim 1, wherein the circuitry is configured to convert a voice recording of the personal data to a digital data stream that is stored in the memory.

11. The apparatus according to claim 1, wherein the pre-stored personal data comprises a plurality of voice recordings in respective multiple languages stored in the memory, and wherein the circuitry is configured to audibly output the pre-stored personal data in a selected language by audibly replaying one from the plurality of stored voice recordings with the preset language.

12. The apparatus according to claim 1, wherein the pre-stored personal data comprises a stored text message, and wherein the circuitry is configured to audibly output the preselected personal data by applying a text-to-speech engine to the stored text message.

13. The apparatus according to claim 1, wherein the pre-stored personal data comprises a plurality of text messages with the pre-stored personal data in respective multiple languages, and wherein the circuitry is configured to select one from the plurality of text messages with a preset language, to apply a text-to-speech engine to the selected text message, and to audibly output the pre-stored personal data in the preset language.

14. The apparatus according to claim 1, wherein the pre-stored personal data comprises a text message with the pre-stored personal data in a first language, and wherein the circuitry is configured to translate the text message from the first language to a preset second language, to apply a text-to-speech engine to the translated text message, and to audibly output the pre-stored personal data in the preset second language.

15. The apparatus according to claim 1, wherein the self-powered power cell comprises a solar cell panel.

16. The apparatus according to claim 1, and further comprising a battery, which is configured to power the circuitry, and wherein the self-powered power cell is configured to charge the battery.

17. The apparatus according to claim 1, wherein the fingerprint scanner comprises an optical fingerprint scanner.

18. The apparatus according to claim 1, wherein the fingerprint scanner comprises a capacitive fingerprint scanner.

19. The apparatus according to claim 1, wherein the fingerprint scanner is configured to detect from the scanned fingerprint whether the subject is alive.

20. A method, comprising:
pre-storing personal data including a fingerprint of a subject in a memory;
comparing a scanned fingerprint with the pre-stored fingerprint of the subject; and
upon authenticating the scanned fingerprint, audibly outputting the pre-stored personal data.
